(19) United States
(12) Patent Application Publication
(10) Pub. No.: US 2009/0208114 A1
(43) Pub. Date: Aug. 20, 2009

(54) Image Processing Apparatus

(75) Inventors: Takashige TANAKA, Matsumoto-shi (JP); Kenji MATSUZAKA, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: Seiko Epson Corporation, Tokyo (JP)

(21) Appl. No.: 12/388,032

(22) Filed: Feb. 18, 2009

(30) Foreign Application Priority Data
Feb. 20, 2008 (JP) 2008-038778

(51) Int. Cl. G06K 9/46

(52) U.S. Cl. 382/199

(57) ABSTRACT

An image processing apparatus that selects at least one photo image out of a plurality of photo images. A face area determining unit detects whether or not there is a face in each photo image and determines a face area of the face, if any, detected in each photo image. An image evaluation processing unit calculates a first edge amount pertaining to the face area detected in each photo image. An image selecting unit selects a photo image from among the plurality of photo images on the basis of the first edge amount of each photo image.

### CROSS-REFERENCE TO RELATED APPLICATIONS

This application claims the benefit of priority under 35 USC 119 of Japanese application no. 2008-038778, filed on Feb. 20, 2008, which is incorporated herein by reference.

### BACKGROUND

The present invention relates to an image processing technique that can be used, for example, for the selection of a photo image.

### RELATED ART

A large number of images may conventionally be stored in a digital camera, a personal computer, and the like. Sometimes a user demands that some images among such a large number of images stored therein should be selected as target images for the purpose of saving, printing, and the like. In an effort to facilitate image selection, various kinds of techniques have been proposed. An example of image selection techniques of the related art is described in JP-A-2007-334594.

A photo image often includes the face of a human. However, image selection techniques of the related art, including that of JP-A-2007-334594, do not take full advantage of the presence of a face in the image for easier image selection.

### SUMMARY

The present invention provides a technique for selecting an image from among a plurality of images in a reliable manner by utilizing a face that is included in the image.

The invention provides, as various aspects thereof, an image processing apparatus, an image processing method, and a computer program having the following novel and inventive features, the non-limiting exemplary configuration and operation of which is described in detail in the DESCRIPTION OF EXEMPLARY EMBODIMENTS.

Application Example 1 (First Aspect of the Invention): An image processing apparatus that selects at least one photo image out of a plurality of photo images includes: a face area determining section that detects whether or not there is a face in each photo image and determines the face area of the face, if any, detected in each photo image; an image evaluation processing section that calculates a first edge amount pertaining to the face area detected in each photo image; and an image selecting section that selects a photo image from among the plurality of photo images on the basis of the first edge amount of each photo image. Since the image processing apparatus according to the first aspect of the invention selects a photo image or images based on the first edge amount pertaining to a face area or areas, it is possible to select at least one photo image that contains a large edge amount pertaining to the face area in a good in-focus state.

Application Example 2: In the image processing apparatus according to the first aspect of the invention, the image evaluation processing section preferably calculates a second edge amount pertaining to either an area other than the detected face area in each photo image or the entire area of each photo image and further calculates a total edge amount by weighted averaging the first and second edge amounts; and the image selecting section performs the selection using the calculated total edge amount. Since the image processing apparatus performs the selection using the total edge amount, which is calculated for each candidate photo image in consideration of the contributions of both the first edge amount of the face area and the second edge amount of the other area, that is, an area other than the face area, it is possible to select at least one photo image that is in a good in-focus state not only in the face area but also in the other area.

Application Example 3; In the image processing apparatus described above, the second edge amount is further preferably an edge amount pertaining to an area other than the face area detected in each photo image; and the weight that is applied to the first edge amount is larger than that applied to the second edge amount in the weighted average calculation. In this configuration, because the weight that is applied to the first edge amount, which pertains to the face area, is larger than that applied to the second edge amount, which pertains to the other area, at least one photo image can be selected with a greater importance being placed on a good in-focus state of the face area than a good in-focus state of the other area while still taking both the in-focus states of the face and other areas into consideration.

Application Example 4: In the image processing apparatus according to the first aspect of the invention, the image evaluation processing section preferably divides the face area into a plurality of sub areas and calculates an edge amount for each of the divided sub areas; and a larger or largest value of the edge amounts of the sub areas is used as the first edge amount if a difference between the calculated edge amounts of the sub areas is not smaller than a predetermined threshold value, whereas the average value of the edge amounts of the sub areas is used as the first edge amount if the difference between the calculated edge amounts of the sub areas is smaller than the predetermined threshold value. An image processing apparatus having this configuration uses, if there is a large difference between the in-focus state of a certain divided sub area corresponding to a part of the face area and the in-focus state of other divided sub area(s), the edge amount of a sub area that is in a better or best in-focus state and has a larger or largest edge amount value is used as the first edge amount, which pertains to the face area. For this reason, for example, when a face shown in a photo image is in profile, that is, for a half-faced image, the edge amount value of a sub area that represents the accurate in-focus state of the face area is used as the first edge amount, which makes it possible to select an appropriate image with improved reliability.

Application Example 5: In the image processing apparatus according to the first aspect of the invention, the image evaluation processing section preferably further calculates one or both of luminance average and luminance variance values for each photo image or each of preselected photo images; and the image selecting section performs the selection on the basis of either one or both of the luminance average and luminance variance values as well as on the basis of the edge amount. With this configuration, since image selection is performed not only with the use of the edge amount but also with the use of the luminance average value and/or the luminance variance value each as an index of image quality, it is possible to select an image or images having preferred image quality.

Application Example 6: In the image processing apparatus according to the first aspect of the invention, if the number of photo images in which a face was detected is N or smaller, where N is a predetermined natural number, all of the photo images in which a-face was detected are preferably selected regardless of the values of the first edge amounts. With this configuration, it is possible to perform image selection with preference being given to an image that includes a face or faces.

Application Example 7: In the image processing apparatus according to the first aspect of the invention, if a difference in the size of the face areas between the photo images is not smaller than a predetermined threshold value, the image selecting section preferably selects a photo image that has a larger or largest face area regardless of the values of the first edge amounts. With this configuration, image selection can be performed with preference being given to a well-photographed image that includes a face shot in a large size.

Application Example 8: In the image processing apparatus according to the first aspect of the invention, where there is more than one face in one photo image, the face area determining section preferably determines a plurality of face areas for the plurality of faces; and the image evaluation processing section uses either the sum of the edge amounts of the plurality of face areas or the average thereof as the first edge amount. With this configuration, the edge amount for an image including more than one face can be appropriately determined.

The present invention can be implemented and/or embodied in a variety of modes. As a few non-limiting examples thereof, the invention can be implemented and/or embodied as, and/or in the form of, an image selection method and/or an image selection apparatus, a method for performing image processing and/or other related processing on a selected image(s), and/or an apparatus for performing image processing and/or other related processing on a selected image(s). As another non-limiting example thereof, the invention can be implemented and/or embodied as, and/or in the form of, a computer program that realizes functions made available by these apparatuses and/or methods, and/or a storage medium that stores such a computer program. In addition, as still another non-limiting example thereof, the invention can be actually implemented and/or embodied as, and/or in the form of, a data signal that contains the content of the computer program and is transmitted via or in the form of a carrier. The above description is provided as non-limiting enumeration for the sole purpose of facilitating the understanding of the invention.

### BRIEF DESCRIPTION OF THE DRAWINGS

The invention will be described with reference to the accompanying drawings, wherein like numbers reference like elements.

FIG. 1 is a schematic diagram of an image processing system according to a first embodiment of the invention.

FIG. 2 is a flowchart of procedures of image selection processing according to the first embodiment of the invention.

FIG. 3 is a flowchart of the detailed processing flow of step T20 of FIG. 2.

FIGS. 4A and 4B are image selection concept diagrams. More specifically, FIG. 4A illustrates selection processing performed in step S30 of FIG. 3, and FIG. 4B illustrates selection processing performed in step S50 of FIG. 3.

FIG. 5 is a diagram that schematically illustrates an example of a method for calculating a total edge amount according to the first embodiment of the invention.

FIG. 6 is a diagram that schematically illustrates another example of a method for calculating a total edge amount according to the first embodiment of the invention.

FIG. 7 is a diagram that schematically illustrates an example of an image selection method that is used when a difference in total edge amounts among a plurality of candidate images is small.

FIG. 8 is a flowchart of the procedures of image selection processing according to a second embodiment of the invention.

FIG. 9 is a flowchart of the procedures of image selection processing according to a third embodiment of the invention.

FIG. 10 is a flowchart of procedures for calculating the edge amount of a face area according to a fourth embodiment of the invention.

FIGS. 11A and 11B are diagrams that schematically illustrate an example of processing according to the fourth embodiment of the invention.

### DESCRIPTION OF EXEMPLARY EMBODIMENTS

With reference to the accompanying drawings, exemplary embodiments of the invention are explained in the following five sections A, B, C, D, and E.

A. First Embodiment

B. Second Embodiment

C. Third Embodiment

D. Fourth Embodiment

E. Variation Examples

### A. First Embodiment

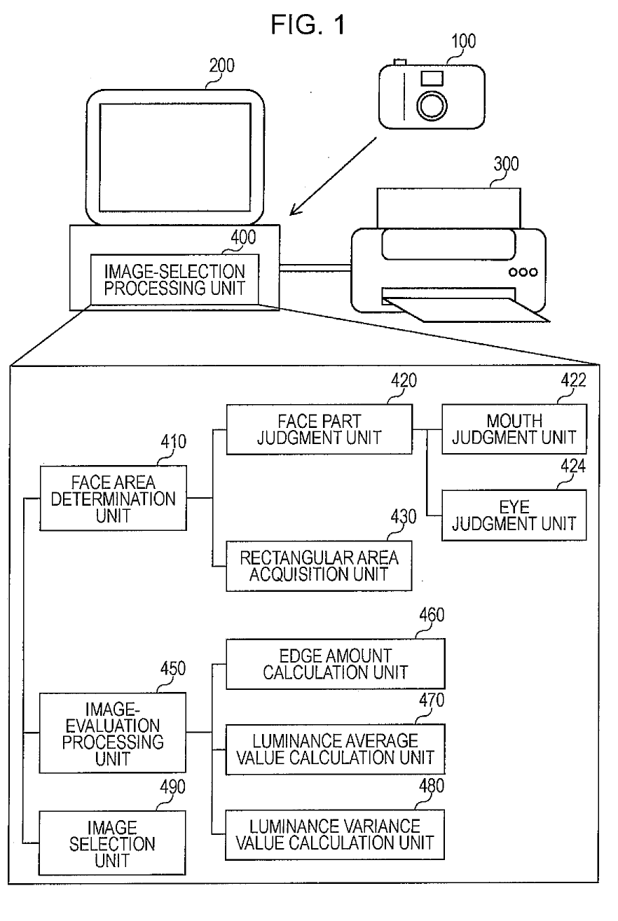

FIG. 1 is a diagram of an image processing system according to a first embodiment of the invention. The image processing system includes a digital camera 100, a personal computer 200, and a color printer 300. The personal computer 200 includes an image-selection processing unit 400 that selects at least one image from among a plurality of photo images. The image-selection processing unit 400 may alternatively be provided in the digital camera 100 or in the color printer 300.

The inner components that make up the image-selection processing unit 400 are illustrated in a tree structure in the lower part of FIG. 1. The image-selection processing unit 400 includes a face area determination unit 410, an image-evaluation processing unit 450, and an image selection unit 490. The face area determination unit 410 determines the face area of each image. The image-evaluation processing unit 450 calculates various kinds of image quality evaluation values for each image. The image selection unit 490 selects an image on the basis of the image quality evaluation values. The face area determination unit 410 includes a face part judgment unit 420 and a rectangular area acquisition unit 430. The face part judgment unit 420 detects face components such as eyes, a mouth, and the like. The rectangular area acquisition unit 430 determines a rectangular face area on the basis of the detected face parts. The face part judgment unit 420 includes a mouth judgment unit 422 and an eye judgment unit 424. The image-evaluation processing unit 450 includes an edge amount calculation unit 460, a luminance average value calculation unit 470, and a luminance variance value calculation unit 480. Having these component units, the image-evaluation processing unit 450 is capable of calculating as image quality evaluation values an edge amount, a luminance average value, and a luminance variance value. The function of each component unit of FIG. 1 can be implemented by means of a computer program that is stored in a computer readable storage medium provided inside the personal computer 200. A non-limiting example of such a storage medium is a hard disk.

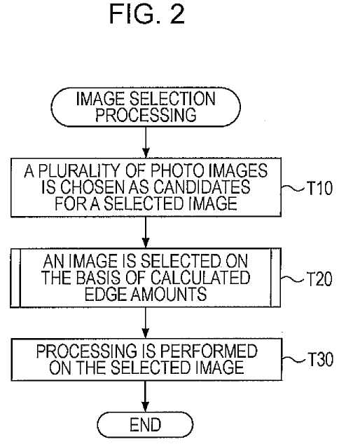

FIG. 2 is a flowchart of the procedures of image selection processing according to the first embodiment of the invention. In step T10, the image-selection processing unit 400 determines a plurality of photo images as candidates for a selected image. In the following description, these candidates for a selected image are referred to as “candidate images”. These candidate images may be automatically extracted out of a number of images that are stored in a memory of the personal computer 200 such as a hard disk or a portable storage medium as images that resemble each other or one another. Or, a user may select these candidate images. In the latter case, the image-selection processing unit 400 preferably displays or causes to be displayed a predetermined selection screen as a user interface window so that a user can select a plurality of candidate images thereon. The number of candidate images that are automatically extracted or selected by a user may be any positive integer excluding one. In step T20, the image-selection processing unit 400 calculates the edge amount of each of the candidate images and then selects an image on the basis of the calculated edge amounts. A more detailed explanation of step T20 will be given later. The image-selection processing unit 400 performs other processing on the selected image in a step T30. This other processing that is performed in the step T30 can include various kinds of image-related processing such as printing, transferring and/or saving an image, without any limitation thereto, as well as so-called image processing such as image quality adjustment and the like.

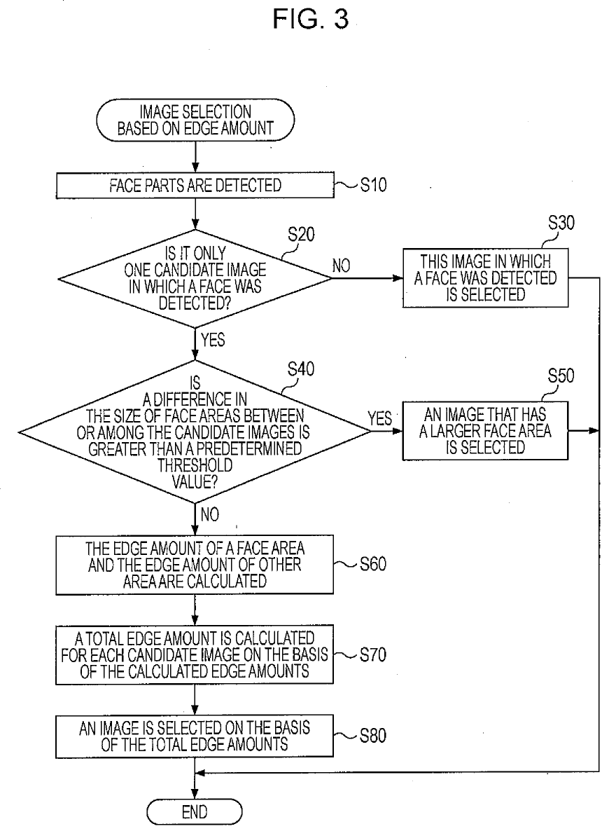

FIG. 3 shows the detailed processing flow of step T20 of FIG. 2. In step S10, the face part judgment unit 420 of FIG. 1 makes a judgment as to whether or not there is any face part such as eyes, a mouth, and the like in each candidate image. The judgment for the individual face parts is made by the mouth judgment unit 422 and the eye judgment unit 424. A face part judgment may also be made for face parts other than the eyes and mouth. The face part judgment unit 420 recognizes that a face is included in an image for which a face part is detected and recognizes that a face is not included in an image for which a face part was not detected.

In step S20, the image selection unit 490 makes a judgment as to whether or not, among the plurality of candidate images, a face(s) was detected in one candidate image only. If a face(s) was detected in one candidate image only, in step S30, the image selection unit 490 selects the one candidate image in which a face(s) was detected and the processing of FIG. 3 ends.

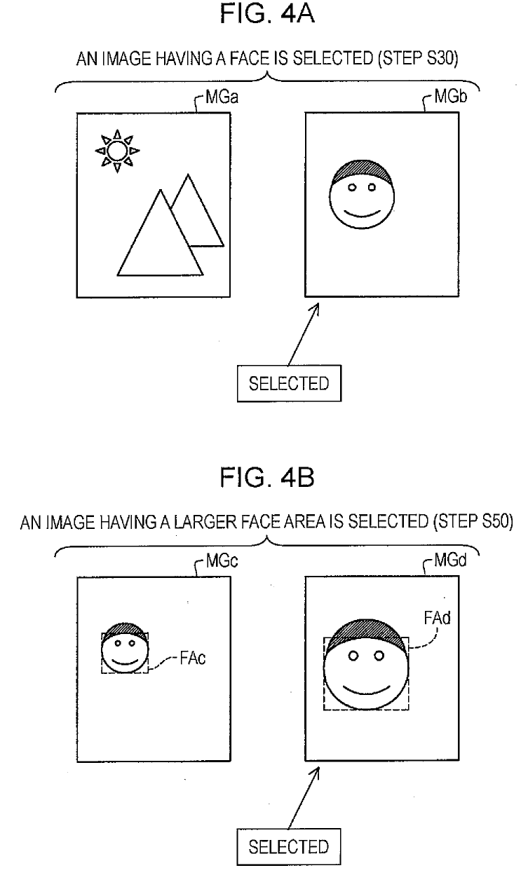

FIG. 4A schematically illustrates an example of the selection processing performed in the step S30. In this example, two candidate images MGa and MGb have been selected in advance, and only the second candidate image MGb includes a face. Therefore, in this example, the second candidate image MGb is selected in the step S30. A candidate image in which a face is shown is selected in the step S30 because a user usually prefers a photo image showing a face.

On the other hand, if it is judged in the step S20 that there is more than one candidate image in which a face was detected, the image selection unit 490 makes a judgment as to whether or not a difference in the size of face areas between or among the candidate images is greater than a predetermined threshold value (step S40). A more detailed explanation of the face areas is given later. If the difference in the size of face areas between the candidate images is greater than the predetermined threshold value, the image selection unit 490 selects the candidate image that has the larger or largest face area in step S50 and the processing of FIG. 3 ends.

FIG. 4B schematically illustrates an example of the selection processing performed in the step S50. In this example, a face is shown in each of two candidate images MGc and MCd. A face area FAc is set for the candidate image MGc. A face area FAd is set for the candidate image MGd. The rectangular area acquisition unit 430 determines these face areas FAc and FAd in the step S40. Or, face areas FAc and FAd may have been predetermined in the previous step S10. For example, the face areas FAc and FAd may each be set as a rectangular area that includes at least one face part that was detected in the step S10. In FIG. 4B, the size of the face area FAd of the second candidate image MGd is larger than that of the face area FAc of the first candidate image MGc. In addition, the difference in sizes of the face areas FAd and FAc is greater than a predetermined threshold value. Therefore, the second candidate image MGd, which has a larger face area, is selected in the step S50. The threshold value is empirically set in advance. In the foregoing explanation, “a difference in size between the face area of one candidate image and the face area of the other is large” has substantially the same meaning as “the area size ratio of one to the other is large”. A candidate image that has a larger face area is selected in the step S50 because a user usually prefers a photo image showing a larger face image. In step S50, when there is more than one face shown in an image, the face area size of that image is preferably compared with that of other images using the larger or largest one of the more than one faces in the image as the basis of comparison.

On the other hand, if it is judged in the step S40 shown in FIG. 3 that a difference in the size of face areas between or among the candidate images is not greater than the predetermined threshold value, steps S60, S70 and S80 are executed. As a first step, the edge amount calculation unit 460 calculates the edge amount of a face area(s) and the edge amount of other area (step S60). Then, the edge amount calculation unit 460 calculates a total edge amount for each candidate image on the basis of the calculated edge amounts (step S70).

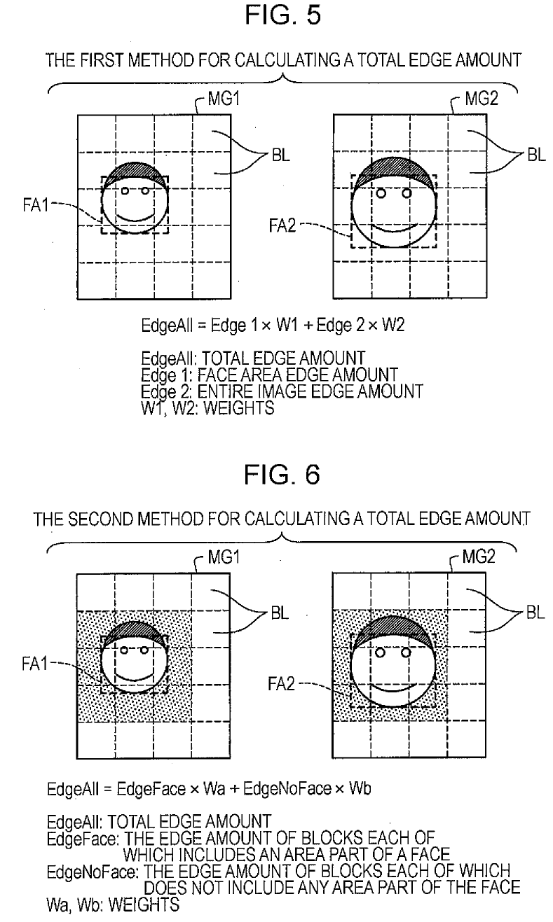

FIG. 5 schematically illustrates an example of a method for calculating a total edge amount according to the first embodiment of the invention. In this example, two candidate images MG1 and MG2 constitute total edge amount calculation target images. The candidate image MG1 has a face area FA1. The candidate image MG2 has a face area FA2. Each of these candidate images MG1 and MG2 is sectioned into a plurality of blocks BL. Each of the blocks BL has a predetermined size. The edge amount calculation unit 460 calculates the edge amount of each of the face areas FA1 and FA2, which is denoted as “Edge 1” in the following description as well as in FIG. 5. For example, the face area edge amount Edge 1 may be calculated by performing filtering processing for each pixel once with the use of a second derivative filter (i.e., Laplacian filter) and then by summing up the results of secondary-differentiation filter processing. A first derivative filter such as a Prewitt filter, a Sobel filter, a Roberts filter, and the like may be used in place of the second derivative filter. The edge amount calculation unit 460 calculates the edge amount of an image as a whole, which is denoted as “Edge 2” in the following description as well as in FIG. 5. The entire image edge amount Edge 2 is a value that is calculated by, for example, summing up the edge amounts of the respective blocks BL, that is, as the aggregate value of the edge amounts calculated on a block-by-block basis. However, the entire image edge amount Edge 2 may also be calculated without partitioning the entire image area into the plurality of blocks BL.

For example, the total edge amount, which is denoted as “EdgeAll” in the following description and drawings, can be calculated using the following formula (1).

EdgeAll=Edge 1×W1+Edge 2×W2 (1)

In formula (1), Edge 1 denotes the face area edge amount, that is, the edge amount of a face area, whereas Edge 2 denotes the entire image edge amount, that is, the edge amount of the entire image. Each of W1 and W2 denotes a weight.

The values of the weights W1 and W2 may be the same or different. In a case where different values are used as the weights W1 and W2, the weight W1 that is applied to the face area edge amount Edge 1 is preferably a relatively large value. The reason that a larger weight value should be used for a face area is as follows. Usually, a face area has a flesh color with a gentle rise and fall. Accordingly, the edge amount of the face area tends to be smaller than that of other area. Therefore, if a weight having a relatively large value is applied to the face area than that applied to other area for the calculation of the total edge amount, it is possible to obtain a desirable total edge amount that faithfully represents the image quality of the face area, especially, the in-focus state of the face area. For this reason, a larger weight value is preferably used for the face area.

Although a larger weight value is preferably used for the face area, the value of the actual weight that is applied to the face area is substantially twice as large as the value of the weight that is applied to other area even when W1 is equal to W2. This is because the entire image edge amount Edge 2 includes the face area edge amount Edge 1. Therefore, it is understood that an actual weight whose value is substantially twice as large as the value of a weight that is applied to other area is applied to the face area even when W1 is equal to W2 in formula (1). In a case where there is more than one face in one image, it is preferable to use either the sum of the edge amounts of the plurality of face areas or the average thereof as the face area edge amount Edge 1.

As a non-limiting modification of the calculation explained above, the total edge amount EdgeAll may be found on the basis of the face area edge amount Edge 1 only, which means that the edge amount of any area other than the face area is not used in the total edge amount calculation. Although it is possible to adopt such a modified calculation method, it is advantageous to include the edge amount of other area in the calculation of the total edge amount EdgeAll because, if so included, the calculated total edge amount EdgeAll further ensures a good in-focus state of a background image part, which is an image part other than the face part of an image. This means that the calculated total edge amount EdgeAll ensures a good in-focus state of both the face and background parts of an image, thereby making it possible to appropriately select an image having a good overall in-focus state.

FIG. 6 schematically illustrates another example of a method for calculating a total edge amount according to the first embodiment of the invention. In this example, the total edge amount EdgeAll is calculated using the following formula (2).

EdgeAll=EdgeFace×Wa+EdgeNoFace×Wb (2)

In formula (2), EdgeFace denotes the face block edge amount, that is, the edge amount of blocks that include an area part of a face, whereas EdgeNoFace denotes the non-face block edge amount, that is, the edge amount of blocks that do not include any area part of the face. Wa and Wb denote weights.

In FIG. 6, each block that overlaps at least a part of the aforementioned face area FA1 or FA2, which is determined on the basis of detected face parts such as the eyes and mouth, is used for the calculation of the face block edge amount EdgeFace corresponding to the face area FA1 or FA2. Specifically, nine blocks arrayed in a 3×3 matrix layout, which is shown as a hatched area in FIG. 6, are used for the calculation of the face block edge amount EdgeFace corresponding to the face area FA1 or FA2. On the other hand, each block that does not overlap any part of the face area FA1 or FA2 is used for the calculation of the non-face block edge amount EdgeNoFace corresponding to an area other than the face area FA1 or FA2. Specifically, in the illustrated example, eleven blocks that surround the above-mentioned 3×3 blocks, which is shown as a blank non-hatched area in FIG. 6, are used for the calculation of the non-face block edge amount EdgeNoFace. In formula (2), the value of the first weight Wa is preferably set larger than the value of the second weight Wb in order to ensure that the value of the weight that is multiplied by the edge amount of the face-area blocks is substantially larger than the value of the weight that is multiplied by the edge amount of the non-face blocks. When formula (2) is used, if there is more than one face in one image, the sum of the edge amounts of the plurality of face areas is preferably used as the face block edge amount EdgeFace.

The weights W1 and W2 of formula (1) or the weights Wa and Wb of formula (2) may be varied depending on the ratio of the area size of the face area(s) to the area size of the entire image. Specifically, for example, the weight W1 or Wa, which is applied to the face area, may be decreased as a percentage value calculated by dividing the area size of the face area(s) by the area size of the entire image increases. In other words, the weight W1 or Wa may be decreased as a face-area occupancy factor increases. With such a variable weight, the contribution of the edge amount of the face area or the face area blocks to the total edge amount can be prevented from being excessively large when the face area occupies a substantially large area part of the image.

Referring back to FIG. 3, in step S80, the image selection unit 490 of FIG. 1 selects a predetermined number of images out of the plurality of candidate images on the basis of the total edge amounts EdgeAll, which have been calculated as explained above. The predetermined number of images that is selected is typically one but not necessarily limited thereto. Herein, the predetermined number of selected images is denoted as M, which is a natural number that can be arbitrarily changed by a user.

In the calculation of the total edge amount EdgeAll according to the present embodiment of the invention, the value of a weight that is multiplied by the edge amount of the face area/blocks is substantially larger than the value of a weight that is multiplied by the edge amount of the non-face area/blocks. For this reason, an image having a relatively large face area/block edge amount is selected in step S80 of the edge-based image selection. Specifically, an image having a relatively good in-focus face state, an image having relatively large face area occupancy, or the like is selected. In most cases, a user chooses such an image as a preferable image. Therefore, image selection according to the present embodiment of the invention has an advantage in that it makes it possible to automatically select a preferable image that is likely to be chosen by a user.

If a difference in the total edge amounts between or among the plurality of candidate images is smaller than a predetermined threshold value, it is possible to adopt, for example, any of the following selection methods.

A1: The first image or the last image of the plurality of candidate images is selected.
A2: When there are three or more candidate images, the center one is selected.
A3: When there are three or more candidate images, the left one and the right one are selected.

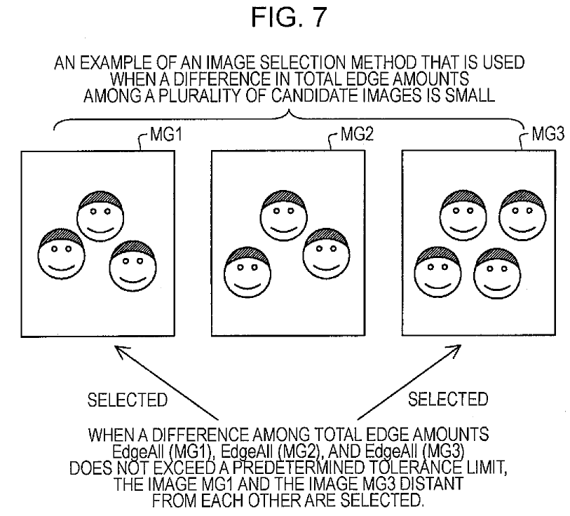

FIG. 7 schematically illustrates image selection using selection method A3. In FIG. 7, when a difference in the total edge amounts among three candidate images MG1, MG2 and MG3 is not larger than a predetermined threshold value, the left image MG1 and the right image MG3 are selected. That is, one-end image MG1 and the other-end image MG3 are selected when a difference in the total edge amounts among three candidate images MG1, MG2 and MG3 does not exceed the predetermined tolerance limit. The reason that these two images are selected is as follows. The one-end and opposite-end images are most distant from each other in terms of photographed point in time because a plurality of images is usually arrayed in sequential order of photographed time. Therefore, these two images are most appropriate in the majority of cases when selected as print target images or other processing target images.

As explained in detail above, in the image selection according to the present embodiment of the invention, a predetermined number of images is automatically selected out of a plurality of candidate images on the basis of the presence/absence of a face area, the size of the face area, and the edge amount of the face area, though not necessarily limited thereto. Therefore, a desirable image(s) that is/are suited for subsequent processing can be easily obtained.

### B. Second Embodiment

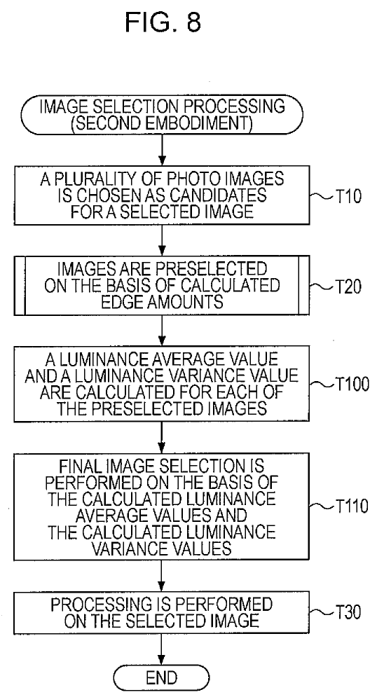

FIG. 8 schematically illustrates image selection processing procedures according to a second embodiment of the invention. The operation flow of FIG. 8 includes additional steps T100 and T110 that are inserted between steps T20 and T30 of FIG. 2. Except for these additional steps T100 and T110, the processing flow of the second embodiment of the invention is the same as that of the first embodiment. In the second embodiment, n-number of images are tentatively selected in step T20, where “n” is a positive integer of two or greater. After the preliminary selection of two or more images in the step T20, final image selection is performed in steps T100 and T110.

In the step T100, the luminance average value calculation unit 470 of FIG. 1 calculates a luminance average value for each of the n-number of images that were tentatively selected in step T20. In addition, in the step T100, the luminance variance value calculation unit 480 of FIG. 1 calculates a luminance variance value for each of the n-number of images that were tentatively selected in step T20. Next, in the step T110, the image selection unit 490 performs final image selection on the basis of the calculated luminance average and luminance variance values. As a modified operation example of the above, either one of the luminance average and luminance variance values may be calculated in the step T100 and then used as a basis of final image selection in the step T110. When both the luminance average and luminance variance values are used, image selection is performed as follows. The luminance average values of the respective images are compared. Then, the image having the largest luminance average value and the image having the second largest luminance average value are selected. A difference between the largest and second largest luminance average values of is calculated. If this difference is not smaller than a predetermined threshold value, the first-mentioned image having the largest luminance average value only is finally selected. It should be noted that this exemplary selection method is described for the purpose of explanation only. Other alternative selection methods may be adopted. If the difference between the largest and second largest luminance average values is smaller than the predetermined threshold value, it is possible to finally select an image having the largest luminance variance value out of images each of which has a large luminance average value. The number of images that are finally selected in the step T10, which is denoted as a natural number M, may be preset.

As explained in detail above, in the image selection according to the second embodiment of the invention, final image selection is performed on the basis of luminance average and luminance variance values after the preliminary selection of images on the basis of edge amounts. Thus, it is possible to select an image(s) having preferred image quality.

### C. Third Embodiment

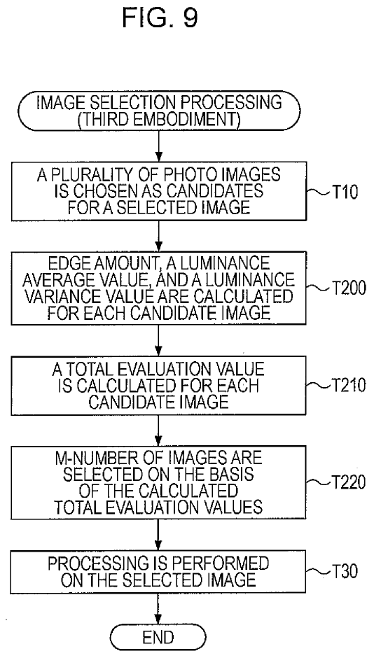

FIG. 9 schematically illustrates image selection processing procedures according to a third embodiment of the invention. The operation flow of FIG. 9 differs from that of FIG. 8 in that steps T20, T100 and T110 are replaced with steps T200, T210 and T220. Except for these substitute steps T200-T220, the processing flow of the third embodiment of the invention is the same as that of the second embodiment.

In the step T200, the image-evaluation processing unit 450 of FIG. 1 calculates an edge amount, a luminance average value, and a luminance variance value for each candidate image. The total edge amount EdgeAll, which was explained in connection with the first embodiment, can be used as the edge amount. In the step T210, the image-evaluation processing unit 450 calculates a total evaluation value for each candidate image, which is denoted as “Etotal” herein, in accordance with the following formula (3).

Etotal=f(EdgeAll, Lave, Ldiv) (3)

In formula (3), “f (EdgeAll, Lave, Ldiv)” indicates that the total evaluation value Etotal is a function that depends on the total edge amount EdgeAll, the luminance average value, which is denoted as “Lave” herein, and the luminance variance value (i.e., luminance “divergence” value), which is denoted as “Ldiv” herein. The face area edge amount Edge 1 or the face block edge amount EdgeFace may be used in place of the total edge amount EdgeAll.

The following formula (3a) is a specific example of formula (3) shown above.

Etotal=α×EdgeAll+β×Lave+γ×Ldiv (3a)

In formula (3a), each of α, β, and γ is a constant (weight).

In the step T220, the image selection unit 490 selects M images using the calculated total evaluation values Etotal, where M is a natural number. As explained in detail above, in the third embodiment of the invention, final image selection is performed using the calculated total evaluation values Etotal. Therefore, it is possible to select an image(s) having preferred image quality on the basis of the edge amounts of images and luminance distribution. As a modification example, either one of the luminance average value Lave and the luminance variance value Ldiv may be used in the calculation of the total evaluation value Etotal shown in formula (3). Moreover, other image quality evaluation values may be used in addition to or in place of the image quality evaluation values described above.

### D. Fourth Embodiment

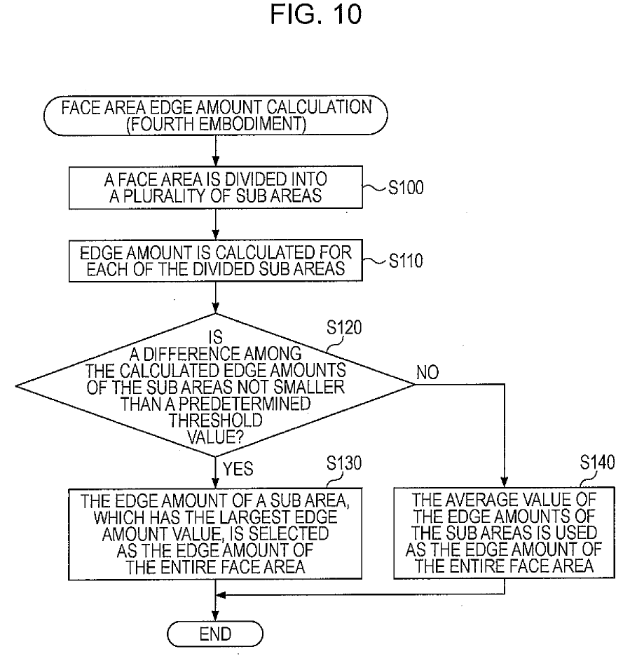

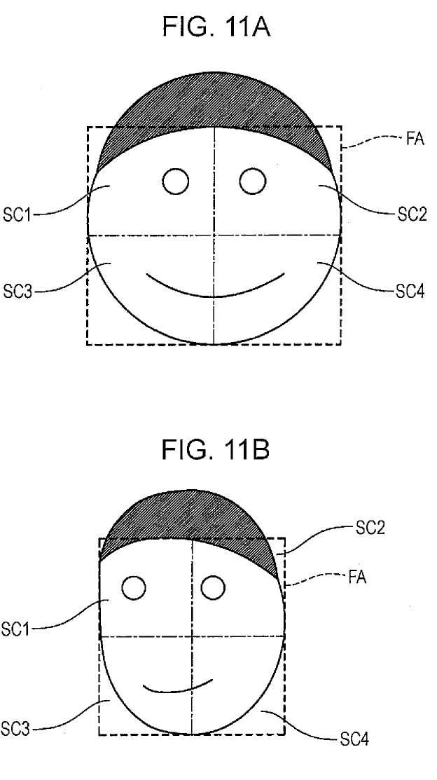

FIG. 10 schematically illustrates procedures for calculating the edge amount of a face area according to a fourth embodiment of the invention. FIGS. 11A and 11B schematically illustrate an example of processing according to the fourth embodiment. The fourth embodiment differs from other embodiments of the invention in its unique method for calculating the edge amount of a face area. Other features such as the configuration, processing, and the like are substantially the same as those of the first, second, or third embodiments of the invention. The edge amount calculation unit 460 of FIG. 1 performs the processing shown in FIG. 10.

In step S100 of FIG. 10, a face area is divided into a plurality of sub areas. In FIGS. 11A and 11B, for example, a rectangular face area FA is divided into four equal sub areas SC1, SC2, SC3, and SC4. In step S110, an edge amount is calculated for each sub area SC1-SC4. As explained in the first embodiment, the edge-amount calculation can be performed with the use of, for example, a first or second derivative filter. Next, in step S120, it is judged whether or not a difference among the calculated edge amounts of the plurality of sub areas SC1-SC4 is not smaller than a predetermined threshold value. For example, the sub area that has the largest edge amount and the sub area that has the second largest edge amount may be selected for the calculation of an edge amount difference therebetween. Then, a judgment is made as to whether the calculated edge amount difference is larger than, or at least equal to, a predetermined threshold value. If the edge amount difference is not smaller than the predetermined threshold value, in step S130, the largest edge amount of the first-mentioned sub area, which has the largest edge amount, is selected as the edge amount of the entire face area FA. On the other hand, if the edge amount difference is smaller than the predetermined threshold value, in step S140, the average value of the edge amounts of the plurality of sub areas SC1-SC4 is used as the edge amount of the entire face area FA.

As explained above, in the face area edge amount calculation according to the fourth embodiment, the edge amount of the entire face area FA is determined depending on the result of a judgment as to whether or not a difference among the calculated edge amounts of the plurality of sub areas SC1-SC4 is not smaller than the predetermined threshold value. This is because the fact that the in-focus state of a certain face sub area could be different from the in-focus state of another face sub area is taken into consideration. For example, when a face is in profile as shown in FIG. 11B, the in-focus states of sub areas SC1-SC4 of the half-faced image considerably differ from one another. Herein, for the purpose of explanation, it is assumed that the second sub area SC2 is in good focus. When the second sub area SC2 is in focus, the edge amount of the second sub area SC2 is considerably larger than the edge amount of the first sub area SC1, the third sub area SC3, and the fourth sub area SC4. Accordingly, in this case, the edge amount of the second sub area SC2, which has the largest value, is selected as the edge amount of the entire face area FA in the step S130 of FIG. 10. By this means, when a local area part of a face is in focus, it is possible to determine the edge amount of a face area on the basis of an edge amount that reflects the in-focus state of the local sub area mentioned above. On the other hand, when the in-focus states of sub areas SC1-SC4 are substantially the same as illustrated in the full-faced image of FIG. 11A, the average value of the edge amounts of the sub areas SC1-SC4 is adopted as the edge amount of the entire face area FA. By this means, it is possible to determine the edge amount of a face area on the basis of an edge amount that reflects the in-focus state of a face as a whole.

As explained in detail above, in the face area edge amount calculation according to the fourth embodiment of the invention, when a local area part of a face is in a good in-focus state, the edge amount of the face area can be determined on the basis of an edge amount that reflects the in-focus state of the local sub area mentioned above. Thus, it is possible to select an image(s) having preferred image quality.

### E. Variation Examples

Although various exemplary embodiments of the present invention are described above, needless to say, the invention is in no case restricted to these exemplary embodiments; the invention may be configured in an adaptable manner in a variety of variations and/or modifications without departing from the spirit thereof. Non-limiting variation examples thereof are explained below.

### E1. First Variation Example

In the foregoing first embodiment of the invention, image selection is performed with the use of a total edge amount calculated for each candidate photo image in consideration of both the contribution of the edge amount of a face area(s) and the contribution of the edge amount of other area, that is, an area other than the face area. However, the scope of this aspect of the invention is not so limited. For example, image selection may be performed on the basis of the face area edge amount only without using the edge amount of other area at all. Even with such a modification, it is possible to perform image selection that reflects the in-focus state of the face area. Although it is possible to adopt such a modification, it is advantageous to include the edge amount of other area in the calculation of the total edge amount because, if so included, the calculated total edge amount further ensures a good in-focus state of a background image part, which is an image part other than the face part of an image.

### E2. Second Variation Example

In the steps S20 and S30 of the image selection processing flow of FIG. 3, if a face is detected in one candidate image only from among a plurality of candidate images, in other words, if the number thereof is one, the one candidate image in which a face(s) was detected is selected. However, the scope of the invention is not limited to this example. For example, if the number of candidate images in which a face(s) was detected is N or smaller, where N is a predetermined natural number, all of the photo images in which a face(s) was detected may be selected. In this modified example, the image selection unit 490 preferably selects all photo images in which a face was detected regardless of the image quality evaluation values of each candidate image.

What is claimed is:

1. An image processing apparatus that selects at least one photo image out of a plurality of photo images, comprising:
a face area determining section that detects whether there is a face in each photo image and determines a face area of the face, if any, detected in each photo image;
an image evaluation processing section that calculates a first edge amount pertaining to the face area detected in each photo image; and
an image selecting section that selects a photo image from among the plurality of photo images on the basis of the first edge amount of each photo image.

2. The image processing apparatus according to claim 1, wherein
the image evaluation processing section calculates a second edge amount pertaining to either an area other than the face area detected in each photo image or the entire area of each photo image and further calculates a total edge amount by weighted averaging the first edge amount and the second edge amount; and
the image selecting section performs the selection with the use of the calculated total edge amount.

3. The image processing apparatus according to claim 2, wherein the second edge amount is an edge amount pertaining to an area other than the face area detected in each photo image; and a weight that is applied to the first edge amount is larger than that applied to the second edge amount in the weighted average calculation.

4. The image processing apparatus according to claim 1, wherein
the image evaluation processing section divides the face area into a plurality of sub areas and calculates an edge amount for each of the divided sub areas;
a larger or largest value of the edge amounts of the sub areas is used as the first edge amount if a difference between the calculated edge amounts of the sub areas is not smaller than a predetermined threshold value; and
the average value of the edge amounts of the sub areas is used as the first edge amount if a difference between the calculated edge amounts of the sub areas is smaller than the predetermined threshold value.

5. The image processing apparatus according to claim 1, wherein
the image evaluation processing section further calculates one or both of a luminance average value and a luminance variance value for each photo image or each of preselected photo images; and
the image selecting section performs the selection on the basis of either one or both of the luminance average and luminance variance values as well as on the basis of the edge amount.

6. The image processing apparatus according to claim 1, wherein, if the number of photo images in which a face was detected is N or smaller, where N is a predetermined natural number, all of the photo images in which a face was detected are selected regardless of the values of the first edge amounts.

7. The image processing apparatus according to claim 1, wherein, if a difference in the size of the face areas between the photo images is not smaller than a predetermined threshold value, the image selecting section selects a photo image that has a larger or largest face area regardless of the values of the first edge amounts.

8. The image processing apparatus according to claim 1, wherein, in a case where there is more than one face in one photo image, the face area determining section determines a plurality of face areas for the plurality of faces; and the image evaluation processing section uses either the sum of the edge amounts of the plurality of face areas or the average thereof as the first edge amount.

9. An image processing method for selecting at least one photo image out of a plurality of photo images, comprising:
a face area determination of detecting whether or not there is a face in each photo image and determining a face area of the face, if any, detected in each photo image;
an image evaluation processing of calculating a first edge amount pertaining to the face area detected in each photo image; and
an image selection of selecting a photo image from among the plurality of photo images on the basis of the first edge amount of each photo image.

10. A computer program embodied on a computer-readable medium that causes a computer to execute image processing for selecting at least one photo image out of a plurality of photo images, comprising:
a face area determination of detecting whether or not there is a face in each photo image and determining a face area of the face, if any, detected in each photo image;
an image evaluation processing of calculating a first edge amount pertaining to the face area detected in each photo image; and
an image selection of selecting a photo image from among the plurality of photo images on the basis of the first edge amount of each photo image.

11. A printer comprising:
a device that can print an image; and
an image processing apparatus that selects at least one photo image out of a plurality of photo images, the image processing apparatus comprising:
a face area determining section that detects whether there is a face in each photo image and determines a face area of the face, if any, detected in each photo image;
an image evaluation processing section that calculates a first edge amount pertaining to the face area detected in each photo image; and
an image selecting section that selects a photo image from among the plurality of photo images on the basis of the first edge amount of each photo image,
wherein, in a case where there is more than one face in one photo image, the face area determining section determines a plurality of face areas for the plurality of faces; and the image evaluation processing section uses either the sum of the edge amounts of the plurality of face areas or the average thereof as the first edge amount.
